(19) United States
(12) Patent Application Publication
(10) Pub. No.: US 2001/0038186 A1
(43) Pub. Date: Nov. 8, 2001

(54) Rolling crutch with braking means

(76) Inventor: Barbara Kling Wychozowycz, Tabernacle, NJ (US)

Correspondence Address: LICATA & TYRRELL P.C., 66 E. MAIN STREET, MARLTON, NJ, 08053, US

(21) Appl. No.: 09/777,377

(22) Filed: Feb. 6, 2001

Related U.S. Application Data
(60) Provisional application No. 60/187,525, filed on Mar. 7, 2000.

(51) Int. Cl. B62B 1/10

(52) U.S. Cl. 280/87.021

(57) ABSTRACT

A rolling crutch for use when one foot requires immobilization is provided which has a braking or stopping mechanism to permit freedom of the hands of the user when stopped and is sized for stair compatibility.

### INTRODUCTION

This application claims the benefit of priority from U.S. Provisional Application Ser. No. 60/187,525, filed Mar. 7, 2000.

### FIELD OF THE INVENTION

The present invention relates to an improved rolling crutch, referred to herein as the “Kling Krutch”, for use by a person having an injured foot ankle or lower leg. The rolling crutch of the present invention has a metal support shaft with a knee support which is both adjustable and collapsible for storage and a base equipped with wheels and a stopping mechanism which allows the user to release hold of the crutch and have use of their hands. The base of the Kling Krutch is preferably sized for stair compatibility.

### BACKGROUND OF THE INVENTION

Various rolling crutches and mobile walking aides have been described.

U.S. Pat. No. 2,652,097 discloses a rolling crutch with a frame structure, a sling supported within the frame structure for resting of the knee, and rollers located at the bottom of the frame structure which support the frame structure and render the crutch movable across the floor. The frame structure is designed to be higher in the front to provide a handle for the user and lower in the back to accommodate the crotch of the person when the uninjured leg is resting on the outside of the frame structure of the crutch.

U.S. Pat. No. 4,867,188 discloses an orthopedic trolley for leg support which allows mobility in cases of injury to the foot or ankle. This orthopedic trolley comprises a knee support structure slidably mounted to a support structure with preferably four or more legs extending therefrom. At the base of each leg is mounted a rotatable wheel.

U.S. Pat. No. 5,411,035 discloses a mobile orthopedic device which supports a disabled leg of a standing patient while the leg is bent at the knee. This device comprises a base with peripheral caster wheels which provides support for a medial upstanding, adjustable support shaft. At the upper portions of the shaft is a padded horizontal support configured to cradle the knee of an injured leg. A handlebar extends from the front of the horizontal support to provide additional support to the user and to aid in maneuvering and steering of the mobile orthopaedic device.

U.S. Pat. No. 5,800,317 discloses an asymmetrical four wheel side support kneeling walker for use by persons in cases of injury or disablement of the lower leg, ankle or foot. The device comprises a cushioned support on a rectangular platform on which the knee of the injured leg rests, a hand-grasping support for guiding the walker, and 4 asymmetrical wheels connected to a supporting frame to provide side support for the kneeling leg. By asymmetrical it is meant that the wheels opposite to the side of the leg which is used for locomotion are offset, in similar fashion to training wheels, to provide adequate support so that the walker does not tip over either while stationary or in motion.

U.S. Pat. No. 5,839,740 discloses a cart for injured persons which provides an alternate to crutches for individuals with an injured leg. The cart has a padded support surface upon which the injured leg can rest and is propelled by the user using their uninjured leg. At the front of the cart are two wheels mounted on forks each having a handlebar that extends upwardly and is padded for user comfort. Hand brakes are also included for gripping of the front wheels upon activation via brake levers on the handlebars. A single, smaller, swiveling wheel is mounted at the back of the leg support of the cart.

U.S. Pat. No. 3,350,095 discloses a braking means which engages upon downward arm pressure by the user for incorporation into walkers and walking aides used commonly by individuals who, due to a physical condition, are unable to walk without assistance.

### SUMMARY OF THE INVENTION

An object of the present invention is to provide an improved rolling crutch with a braking or stopping mechanism to permit freedom of the hands of the user when stopped. The rolling crutch comprises a lightweight metal shaft, preferably comprised of several interconnecting pieces for height adjustment, said shaft having a top and a bottom. A cushioned knee pad is mounted to the metal shaft and extends perpendicularly from the shaft at a height which is comfortable for the user to rest the knee of the injured leg. A handlebar is mounted at the top of the metal shaft. A rectangular base is mounted at the bottom of the shaft and extends perpendicularly from the shaft in the same direction as the cushioned knee pad. In a preferred embodiment, the base of the crutch is sized for stair compatibility. Wheels with a braking or stopping mechanism which engages upon application of weight downward on the handlebar and base are mounted on each corner of the rectangular base so that the crutch slides easily across the ground until engaging of the stopping mechanism.

### BRIEF DESCRIPTION OF THE FIGURES

FIG. 1 is a side view of a rolling crutch of the present invention.

FIG. 2 is another side view of the crutch and depicts an individual resting their knee in the crutch.

FIG. 3 is a front view of a rolling crutch of the present invention.

FIG. 4 is a top view of the rolling crutch of the present invention.

### DETAILED DESCRIPTION OF THE INVENTION

The present invention relates to a new crutch for use by an individual when one foot requires immobilization and/or can not bear weight for a period of time. Unlike the standard wooden crutch which requires hand use for balance at all times, an individual using this new crutch has use of their hands when stopped. This freedom is possible because the weight of the user is evenly distributed between the functioning leg and a knee rest of the crutch. Accordingly, with the rolling crutch of the present invention an individual is able to perform multiple everyday tasks which require two hands to accomplish while still resting the injured leg.

In simplest form, this new crutch, referred to herein as the “Kling Krutch” comprises a metal shaft with a top and bottom, a cushioned knee pad mounted to the metal shaft and extending perpendicularly from the shaft at a height which is comfortable for the user to rest the knee of the injured leg, a handlebar mounted at the top of the metal shaft, and a rectangular base mounted at the bottom of the metal shaft which also extends perpendicularly from the metal shaft in the same direction as the cushioned knee pad. The Kling Krutch further comprises wheels with a braking or stopping mechanism which engages upon application of weight downward on the handlebar which are mounted on each corner of the rectangular bottom portion of the base so that the crutch can slide across the ground.

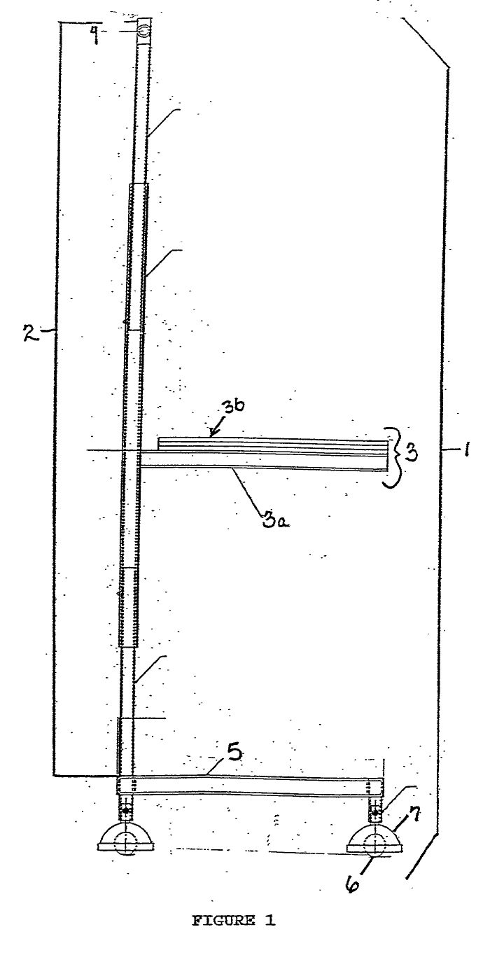

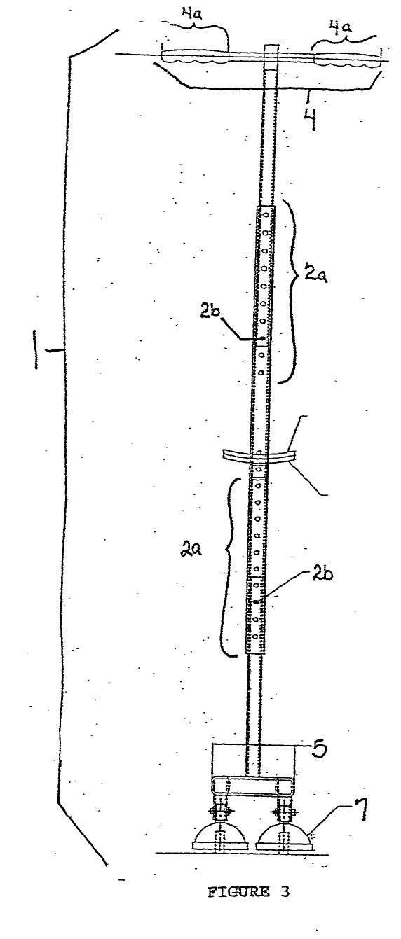

FIGS. 1-4 show a preferred embodiment of the Kling Krutch. As shown in FIG. 1-3, in a preferred embodiment, the metal shaft 2 of the Kling Krutch 1 comprises several interlocking pieces, preferably four pieces, for height adjustment of the handlebar 4 and knee pad 3. It is also preferred that each piece be hollow and comprise a lightweight strong metal such as those commonly used in walkers and bath tub chairs. Each hollow tube is preferably round with an outer tube width of either 1 inch or ¾ inch so that they may be interconnected to form the metal shaft 2. As depicted in FIG. 3, a series of holes 2a are drilled into the metal shaft at each interconnection and a push button 2b is incorporated for adjustment of these interconnections to a selected height. As will be obvious to those of skill in the art upon this disclosure, however, other means for adjusting the height of the metal shaft can also be used.

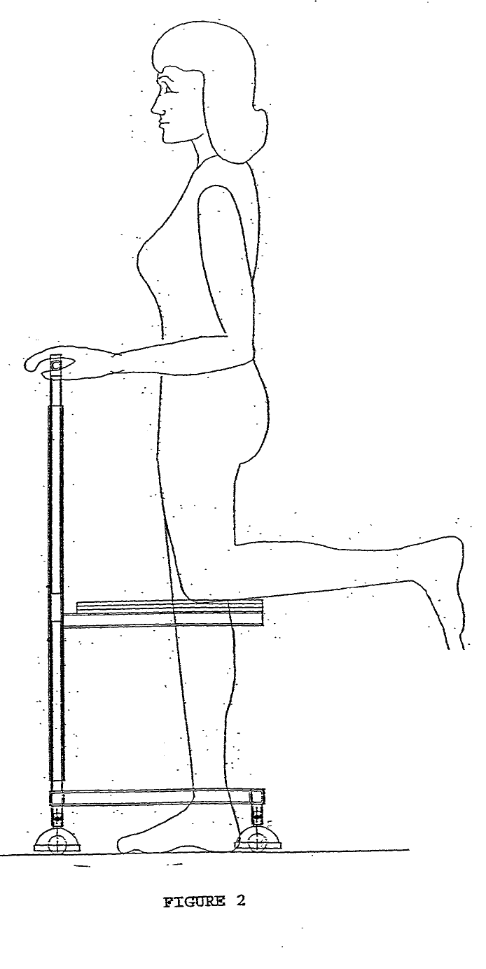

A cushioned knee pad 3 is mounted to the metal shaft 2 and extends perpendicularly with respect to the metal shaft 2. The knee pad can be positioned at a height, as depicted in FIG. 2, which is comfortable for the user to rest the knee of the injured leg by adjusting the height of the metal shaft 2. In a preferred embodiment, the cushioned knee pad 3 comprises a metal frame or platform 3a covered with a plastic pad 3b. The surface of the pad 3b is covered with a removable, stretchable rubber padding for easy cleaning and replacement upon wear. The plastic padding 3b is preferably pre-shaped and fitted for comfort and to prevent sliding.

A handlebar 4 with handgrips 4a on each end of the handlebar 4 is mounted perpendicularly at the top of the metal shaft 2 so that handlebar 4 extends horizontally at equal lengths in a T-shaped fashion with respect to the shaft 2 and at a 90 degree angle with respect to the knee pad 3. Height of the handlebar 4 is adjusted for each user by altering the height of the metal shaft 2. In a preferred embodiment, the handlebar 4 extends approximately 6 inches on each side of the shaft 2.

A rectangular base 5 is mounted at the bottom of the metal shaft 2 and also extends perpendicularly with respect to the shaft 2 in the same direction as the knee pad 3. In a preferred embodiment, the rectangular base 5 extends approximately 15 inches in length from the shaft 2 and approximately 2 to 3 inches in width on either side from the shaft 2 so that the base of the Kling Krutch will easily fit on any standard step, thus making the Kling Krutch stair compatible.

A wheel 6 with a braking or stopping mechanism 7 is mounted on each corner of the rectangular base 5 for easy sliding of the Kling Krutch across the floor. In a preferred embodiment the wheels 6 and braking mechanism 7 comprise castors with a rubber caps that descend when weight is applied. As little as fifty pounds of pressure downward will engage the rubber caps thereby stopping rolling of the Kling Krutch. Thus, when the rubber cap is engaged, the Kling Krutch is stationary and secure, allowing the user to release hold of the handlebar to regain mobility and use of their hands. However, the castors have a full 360-degree range of motion, making forward movement, turning and reversing easy when the user is in motion. Thus, this wheel and braking mechanism design provides mobility without weight and stability when weight is applied.

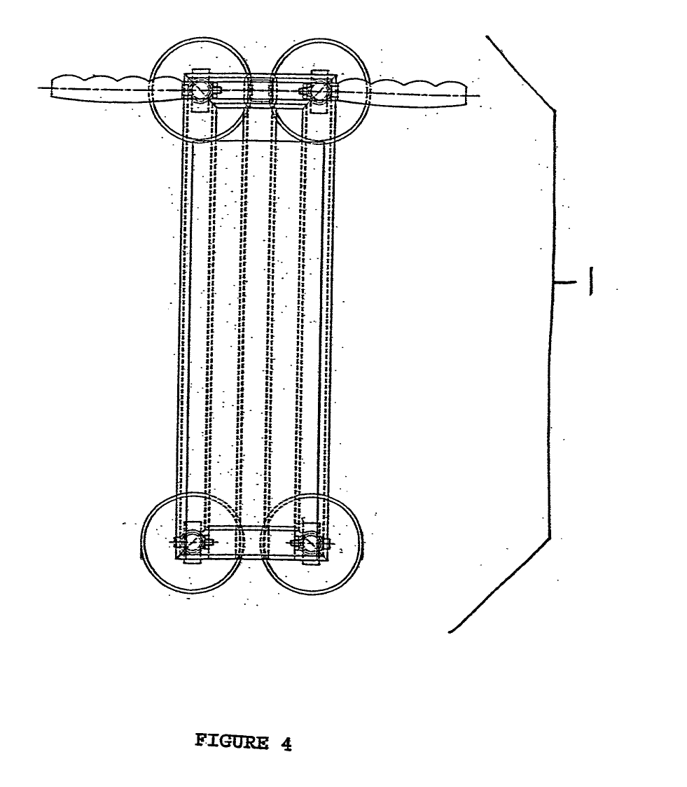

As depicted in FIG. 4, this design of the Kling Krutch permits easy folding for storage when the Kling Krutch is not in use or when traveling.

What is claimed is:

1. A rolling crutch comprising:
(a) a lightweight metal support shaft, said shaft having a top and a bottom;
(b) a cushioned knee pad mounted to the shaft and extending perpendicularly from the shaft at a position which is comfortable for a user to rest a knee of an injured leg;
(c) a handlebar mounted at the top of the shaft and extending perpendicularly with respect to the shaft at a 90 degree angle with respect to the knee pad;
(d) a rectangular base mounted at the bottom of the shaft and extending perpendicularly from the shaft in the same direction as the cushioned knee pad; and
(c) wheels with a stopping mechanism mounted on each corner of the rectangular base, wherein the stopping mechanism engages upon application of weight downward on the crutch.

2. The rolling crutch of claim 1 wherein the metal support shaft comprises multiple interconnecting hollow metal tubes so that the shaft is adjustable to a selected height.

3. The rolling crutch of claim 1 wherein the base is sized for stair compatibility.
